(19) United States
(12) Patent Application Publication
(10) Pub. No.: US 2011/0115714 A1
(43) Pub. Date: May 19, 2011

(54) INTERFACE SYSTEM FOR ENTERING A STRING OF CHARACTERS

(75) Inventor: Steve Lecocq, Le Chesnay (FR)

(73) Assignee: CONTINENTAL AUTOMOTIVE FRANCE, Toulouse (FR)

(21) Appl. No.: 13/003,439

(22) PCT Filed: Jul. 17, 2009
(86) PCT No.: PCT/EP09/05213

§ 371 Date: Jan. 10, 2011

(30) Foreign Application Priority Data
Jul. 25, 2008 (FR) 0804242

(51) Int. Cl. G06F 3/02

(52) U.S. Cl. 345/169

(57) ABSTRACT

Interface system (1) for entering a string of characters in an entry mode, the system comprising at least two display windows (101, 102, 103, 104) for displaying characters to be selected from among at least one series, a rotary thumbwheel (100) for modifying the circular correspondence between the windows (101, 102, 103, 104) and the one or more series, means of designation (100) of one of the windows (101, 102, 103, 104) for selecting the character which is displayed therein and storage means for storing a string of characters thus selected following several successive rotations of the thumbwheel, noteworthy in that the series of characters is unique for the set of windows, the windows (101, 102, 103, 104) being regularly spaced along the series.

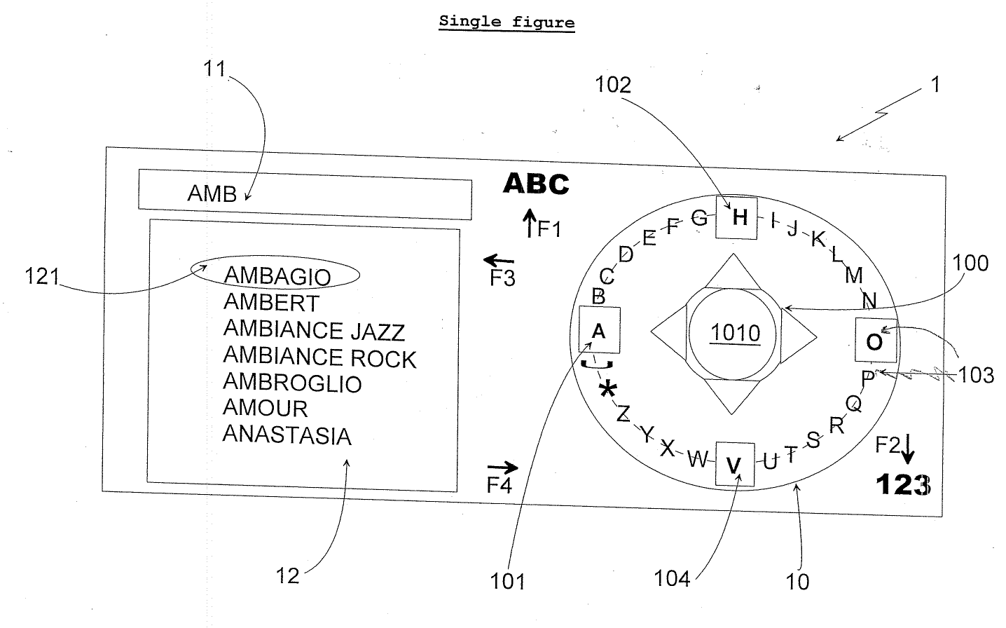

The invention relates to an interface system for entering a string of characters.

The most common way of entering a text or a word is a keyboard, for example a computer keyboard, comprising a large number of keys each associated with a character. However, for portable or onboard apparatuses, the room for such a keyboard is not sufficiently available, or a keyboard of restricted size could not be used in a practical manner. Such is the case for example for portable telephones, navigation aid systems or personal stereos, autonomous or onboard a vehicle.

This is why it has been sought to develop interface systems using a restricted number of keys or actuators.

Document WO 02/091160 shows for example an interface system comprising four buttons distributed in a rose around a thumbwheel. A display displays a series of characters distributed over three lines. A cursor is placed on this series so as to bracket a character of each line, i.e. three characters, distributed according to an arrangement corresponding to three of the four buttons of the rose. The rotation of the thumbwheel makes it possible to displace the cursor along the series of characters. Pressing one of the three buttons makes it possible to designate a character to be selected.

Even if the number of buttons used is restricted, this system requires that a complete series of characters be displayed, thus requiring a non-negligible display area. Moreover, if two successive characters to be selected are arranged at the opposite ends of the lines, it is necessary to displace the cursor with the thumbwheel by the entirety of the number of characters contained in each line.

The invention is therefore aimed at providing an interface system for entering a string of characters which comprises a limited number of keys or actuators, which requires few actions to designate each character and which is compact.

With these objectives in view, the subject of the invention is an interface system for entering a string of characters in an entry mode, the system comprising at least two display windows for displaying characters to be selected from among at least one series, a rotary thumbwheel for modifying the circular correspondence between the windows and the one or more series, means of designation of one of the windows for selecting the character which is displayed therein and storage means for storing a string of characters thus selected following several successive rotations of the thumbwheel, noteworthy in that the series of characters is unique for the set of windows, the windows being regularly spaced along the series.

Stated otherwise, the series does not exhibit any ends, and, from a given position, each other character of the series can be reached through a rotation of the thumbwheel in one direction or in the other direction. Therefore, if access to a character through a rotation in one of the directions exceeds half the number of characters, access through the other direction will be through a number of notches which is less than half the number of characters. Through this choice of the direction of movement, the displacement is at most half the number of characters. Thus, by virtue of the invention, the maximum movement of the characters in a display window is substantially halved. The number of actions for choosing a character is therefore restricted.

In a preferential manner, the windows ate fixed, the rotation of the thumbwheel scrolling the one or more series through the windows. Thus, the user does not look around for where the character that is liable to be selected is situated, he finds it directly in the position of the window. Moreover, the presentation of the characters in just the windows makes it possible to restrict the area used by the interface system. If all the characters are displayed, just those in the windows may be displayed in a large size, the other characters possibly being displayed a smaller size.

In a particular manner, the windows are distributed over a disk at the center of which the thumbwheel is placed. The series takes the form of a disk, real or virtual, at the periphery of which the windows are situated. The user readily assimilates the configuration of the disk and easily establishes where the characters are, so as to determine in which direction to actuate the thumbwheel.

According to a refinement, the system comprises permutation means for exchanging the series of characters with at least one other series. The number of accessible characters is thus multiplied. It is possible to have a first series of letters, and a second series of digits and of special characters.

According to another refinement, to embody the designation means, the thumbwheel is also mobile in the direction of each window, displacement toward one of the windows making it possible to select the character displayed in said window. The designation means are thus intuitive. The thumbwheel is for example mounted pivoting on its base, in the manner of a “joystick”. It could be sliding.

In a particular manner, the system comprises a display for displaying the string of characters selected.

According to a refinement, the system comprises a list zone for displaying a list of titles in concordance with the string of characters selected. This makes it possible to accelerate the selection of the desired title, after the number of choices is sufficiently restricted through the first characters selected.

In a complementary manner, the system comprises mode selection means for selecting either the entry mode, or a list mode in which the rotation of the thumbwheel displaces a selection by one title in the list. By switching from one mode to the other, the thumbwheel may be used either to designate a character, in the entry mode, or to choose a title from the list, in the list mode.

The invention will be better understood and other features and advantages will become apparent, on reading the description which follows, the description referring to the single FIGURE which shows the front plate of a system in accordance with the invention.

The embodiment of the invention, exhibited in the single FIGURE, is an interface system 1 for a multimedia reader onboard a vehicle. It stores a large number of titles, for example pieces of music, and its interface system 1 must make it possible to choose one of the titles while requiring the least possible concentration from the user who may be the driver.

The front plate of the interface system 1 comprises an entry zone 10, on the right in the FIGURE, a display 11 and a list zone 12, on the left in the FIGURE. The list zone 12 is placed under the display 11. The display 11 makes it possible to display a line of characters.

The entry zone 10 comprises a thumbwheel 100 projecting from the front plate and designed to be manipulated with the fingers by a user. The thumbwheel 100 is at the center of a disk. Four windows 101, 102, 103, 104 are arranged respectively on the right, on the left, above and below the thumbwheel 100, on the periphery of the disk. The thumbwheel 100 is rotary about an axis substantially perpendicular to the front plate. Its rotation is indexed over 28 positions over a revolution. It is also mounted pivoting about two axes so as to be able to tilt slightly toward each of the windows 101, 102, 103, 104. A central button 1010 is provided at the center of the thumbwheel 100.

The system also comprises storage means, not represented, for storing a string of selected characters.

On enabling the apparatus, the system is for example in an entry mode. In this mode, the rotation of the thumbwheel 100 causes a change of character displayed in each window 101, 102, 103, 104. The replacement character is a character adjacent to that displayed previously, considered in a series of characters and according to the direction of rotation of the thumbwheel 100. By way of illustration, the series is an alphabetic list followed by the characters “*” and a space. The first window 101 initially contains an “A”, the second window 102 contains an “H”, the third window 103 contains an “O” while the fourth window 104 contains a “V”.

When the thumbwheel 100 is rotated by one notch, that is to say 1/28^{th} of a revolution clockwise, a space is displayed in the first window 101, a “G” in the second window 102, an “N” in the third window 103 and a “U” in the fourth window 104.

If, from the initial position, a rotation of 1/28^{th} of an anticlockwise revolution is performed, a “B” is displayed in the first window 101, an “I” in the second window 102, a “P” in the third window 103 and an “X” in the fourth window 104.

From the initial position, the user pushes the thumbwheel 100 to the left, toward the first window 101, and the character “A” is selected, stored by the storage means and displayed on the display 11. Next he rotates the thumbwheel 100 two notches clockwise so as to display an “M” in the third window 103. He pushes the thumbwheel 100 to the right toward the third window 103, thereby selecting the “M”. This letter is stored and added to the right of the letter “A” on the display 11 so as to form the word “AM”. Next the thumbwheel 100 is rotated three notches anticlockwise, so as to display a “B” in the first window 101. The user pushes the thumbwheel 100 to the left, toward the first window 101 and the character “B” is selected, stored and added to the display 11 so as to form the word “AMB”.

At the same time, the content of the list zone 12 is adapted. It contains several lines, each line corresponding to a stored title or to a category. Each title or category is arranged in alphabetical order and the first title of the list zone 12, at the top, is the first corresponding to the word selected and shown on the display 11. The first line 121 is highlighted (in the FIGURE the highlighting is depicted by an ellipse surrounding the word AMBAGIO). Pressing the central button 1010 orders the reading of the title designated by the highlighting.

By significantly pressing toward the top (arrow F1) on the thumbwheel 100, the user orders a change of series displayed in the windows. This causes a switch from an alphabetic series to a numeric series. To switch from the alphanumeric series to the numeric series it suffices to press significantly toward the bottom (arrow F2).

By significantly pressing the thumbwheel 100 toward the left (arrow F3), the user orders a change of mode, so as to switch to a list mode. He can return to the entry mode by significantly pressing the thumbwheel 100 toward the right (arrow F4).

The significant pressure exerted corresponds to a pivoting travel of the thumbwheel 100 that is bigger than that for obtaining the selection of a character in one of the windows (101 to 104).

In the list mode, the rotation of the thumbwheel 100 modifies the content of the list zone 12 by scrolling the list of titles in alphabetical order. One of the lines is highlighted. Pressing the central button 1010 orders the reading of the title designated by the highlighting.

The invention is not limited to the embodiment described solely by way of example. Alphabetical order is not necessarily used to present the series of characters or the list of titles. The intermediate characters between the windows may be displayed, as is represented, or hidden, so as to limit the area used by the system.

1. An interface system (1) for entering a string of characters in an entry mode, the system comprising at least, two display windows (101, 102, 103, 104) for displaying characters to be selected from among at least, one series, a rotary thumbwheel (100) for modifying the circular correspondence between the windows (101, 102, 103, 104) and the one or more series, means of designation (100) of one of the windows (101, 102, 103, 104) for selecting the character which is displayed therein and storage means for storing a string of characters thus selected following several successive rotations of the thumbwheel, characterized in that the series of characters is unique for the set of windows, the windows (101, 102, 103, 104) being regularly spaced along the series.

2. The system as claimed in claim 1, in which the windows (101, 102, 103, 104) are fixed, the rotation of the thumbwheel (100) scrolling the one or more series through the windows (101, 102, 103, 104).

3. The system as claimed in claim 1, in which the windows (101, 102, 103, 104) are distributed over a disk at the center of which the thumbwheel (100) is placed.

4. The system as claimed in claim 1, characterized in that it comprises permutation means (100) for exchanging the series of characters with at least one other series.

5. The system as claimed in claim 1, in which, to embody the designation means, the thumbwheel (100) is also mobile in the direction of each window (101, 102, 103, 104), the displacement toward one of the windows making it possible to select the character displayed in said window.

6. The system as claimed in claim 1, characterized in that it comprises a display (11) for displaying the string of characters selected.

7. The system as claimed in claim 6, characterized in that it comprises a list zone (12) for displaying a list of words in concordance with the string of characters selected.

8. The system as claimed in claim 7, characterized in that it comprises mode selection means (100) for selecting either the entry mode, or a list mode in which the rotation of the thumbwheel (100) displaces a selection by one title in the list.
